(19) United States
(12) Patent Application Publication
(10) Pub. No.: US 2009/0210475 A1
(43) Pub. Date: Aug. 20, 2009

(54) RECOMMENDATION SYSTEM AND METHOD OF OPERATION THEREFOR

(75) Inventors: SANDRA C. GADANHO, Reading (GB); CRAIG C. WATSON, Southampton (GB)

Correspondence Address: MOTOROLA INC, 600 NORTH US HIGHWAY 45, W4 - 39Q, LIBERTYVILLE, IL, 60048-5343, US

(73) Assignee: MOTOROLA INC., Libertyville, IL (US)

(21) Appl. No.: 12/032,752

(22) Filed: Feb. 18, 2008

(51) Int. Cl. G06F 15/16

(52) U.S. Cl. 709/201

(57) ABSTRACT

A recommendation system comprises a plurality of recommenders for generating recommendations in accordance with a user preference profile having a recommender specific representation. The recommender specific representation is different for different recommenders and each recommender comprises translation data relating the recommender specific representation to a shared ontology. A recommender comprises a translation unit which generates first user preference data in accordance with the shared ontology in response to a user preference profile and translation data relating the recommender specific representation to the shared ontology. In addition, a confidence indication for at least part of the user preference data is generated. A transmitter transmits the user preference data and the confidence indication to a second recommender. The second recommender may translate the received data into its recommender specific representation and combine the received data with locally generated user preference data. The invention may facilitate and/or improve sharing of user preference data.

### FIELD OF THE INVENTION

The invention relates to a recommendation system and in particular, but not exclusively, to a recommendation system for content items such as multimedia clips, radio or television programmes etc.

### BACKGROUND OF THE INVENTION

Personalisation of applications and services to the preferences, needs and characteristics of each individual user is becoming increasingly widespread and important.

For example, as increasing amounts of content and options become more readily available through different means, different types of applications make use of diverse recommendation tools that help the user. Accordingly, recommender systems have become commonplace as a way to help people navigate among increasingly more complex selection options. Solutions have been offered to increasingly more varied domains including helping to select a book purchase, a cinema, a television-program, a restaurant, a video to rent, etc. Solutions are usually tailored to their specific domain so that advantage can be taken from associated domain knowledge.

As a result, people's preferences have become fragmented among multiple recommender systems that are oblivious of each other. Indeed, different recommenders, not only model different dimensions of user's preferences (e.g., films, television shows or books) but also model these user preferences differently. The user preference models are usually targeted to the specific problem domain and depend highly on the specific recommendation approach and algorithms.

For example, even for a specific group of recommenders, such as recommenders for television programmes, very different algorithms may be used for different means of access to the television programmes (e.g., different recommenders are used dependent on whether access is via broadcast television, web download, rental, e-commerce or mobile television services such as Digital Video Broadcast-Handheld (DVB-H).

Accordingly, user preference models are typically generated individually for each recommender such that they reflect the specific requirements and characteristics of the individual recommender application. For example, in the domain of traditional television broadcasts, the broadcast time can be an important consideration in the recommendation process. However, this property has little or no use in other domains where content is accessed on demand. Indeed, it may be a property that translates poorly even to other domains also having broadcast times. E.g. as the typical times a user watches terrestrial television tend to be different from the typical times of watching mobile television, a conventional terrestrial broadcast time studied by a terrestrial television recommender may not be a relevant parameter for a mobile television recommender.

It would be desirable to be able to share user preference information between different recommenders. Such sharing would in many scenarios provide a more accurate reflection of a user's preferences as the developed user preference information or model can be based on a larger sample and reflect the user's actions and ratings in an increased variety of situations. However, such sharing tends to be difficult to achieve due to the user preference data typically being closely linked to the individual recommending algorithm and therefore preference data generated by one application is typically not compatible with other recommendation algorithms.

Accordingly, existing systems for sharing user preference data typically require that the recommendations use the same algorithm or at least that the user preference data is represented/structured identically. For example, it has been proposed that different recommenders may structure the user preference data in accordance with the same ontology and that these recommenders may share user preference data as this is directly compatible. However, such an approach is not suitable for sharing between recommenders using different user preference structures and representations and tends to impose undesirable restrictions on the design of the individual recommender.

Another problem of user preference data sharing is that of determining which data to share in order to optimise the potential benefit. In particular, in order to optimise the synergistic effect of sharing user preference information, it is critical that suitable data is exchanged between the recommenders.

Hence, an improved recommendation system would be advantageous and in particular a system allowing increased flexibility, improved sharing of user preference data, improved recommendations, facilitated implementation, facilitated operation, facilitated sharing between different recommenders and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a recommendation system comprising: a plurality of recommenders for generating recommendations in accordance with a user preference profile having a recommender specific representation, the recommender specific representation being different for different recommenders of the plurality of recommenders and each recommender of the plurality of recommenders further comprising translation data relating the recommender specific representation to a shared ontology; wherein at least a first recommender of the plurality of recommenders comprises: a translation unit for generating first user preference data represented in accordance with the shared ontology in response to a first user preference profile of the first recommender and first translation data relating a first recommender specific representation of the first user preference profile to the shared ontology; and a transmitter for transmitting the first user preference data to a second recommender of the plurality of recommenders; and the translation unit is further arranged to generate a confidence indication for at least some of the first user preference data and the transmitter is arranged to transmit the confidence indication to the second recommender.

The invention may provide an improved recommendation system. In particular, the invention may enable and/or facilitate sharing of user preference information thereby allowing improved accuracy and/or diversity of generated recommendations. Sharing of confidence information allows the shared user preference information to be used more accurately and for example allows a recommender to weigh received user preference information relative to locally generated user preference information.

The use of a shared ontology facilitates sharing of user preference information and may in particular provide a suitable means for providing the confidence information. For example, the confidence information may comprise a confidence measure for one or more categories of the shared ontology. Specifically, for at least some categories of the shared ontology that are associated with a user preference value, a confidence measure may also be included that reflects the confidence in that user preference value.

The confidence indication can be indicative of an estimated likelihood that the user preference data corresponds to the user's preferences. In particular, the confidence indication may comprise a plurality of confidence measures each being associated with a user preference data item of the user preference data. The confidence measure of a user preference data item indicates an estimated likelihood that the user preference data accurately (or correctly) reflects a user's preference. Thus, the confidence indication may be indicative of a reliability or degree of evidence support for the user preference data.

The invention may for example allow recommenders to provide more accurate and/or diverse recommendations. For example, user preferences determined for completely different domains may be used to influence each other. Furthermore, the approach to sharing may allow or facilitate interworking for existing recommendation algorithms. For example, the invention may allow or facilitate that a user's preferences for book purchasing can be used to generate recommendations of television programmes.

A recommender specific representation can specifically define how user preference data is represented in the user preference profile but may be independent of the user preference data itself. For example, the recommender specific representation may be determined during manufacturing or design of the recommender. During operation, the user preference profile may be populated/generated/modified by the determined user preference data in accordance with the recommender specific representation. The recommender specific representation may specifically be independent of the user's preferences.

The internal representation of the user preference profile for the individual recommenders is different. Thus, not only is the actual user data different but the arrangement of the user data is different. Specifically, the structure, arrangement, configuration, organisation of the user preference profile is different. Specifically, for at least some user data of a representation of one recommender there may be no direct equivalent in a representation used by a different recommender. Specifically, the recommender specific representations may represent different domains which may be non-overlapping.

A recommender specific representation is not necessarily limited to a specific recommender but may be used by e.g. identical but separate recommenders. For example, recommenders for recommending radio programmes may be designed to use similar or identical recommender specific representations.

In some embodiments, the recommender specific representations may correspond to different types of user preference profiles. For example, one representation may correspond to a probabilistic user model, another one to a complex non-probabilistic user model, another one to a simple taxonomy, another one to clustering of recommendation items, another one to a neural network, another one to case based reasoning etc. The use of a shared ontology may in such examples substantially facilitate interworking between recommenders.

The shared ontology may specifically be an ontology defining representation of content data. In some embodiments, the shared ontology does not include (or allow) context data. Such data may in some applications loose significance from one application to another.

The shared ontology may specifically be a shared taxonomy.

According to an aspect of the invention there is provided a method of operation for a recommendation system comprising a plurality of recommenders for generating recommendations in accordance with a user preference profile having a recommender specific representation, the recommender specific representation being different for different recommenders of the plurality of recommenders and each recommender of the plurality of recommenders further comprising translation data relating the recommender specific representation to a shared ontology; the method comprising a first recommender of the plurality of recommenders performing the steps of: generating first user preference data represented in accordance with the shared ontology in response to a first user preference profile of the first recommender and first translation data relating a first recommender specific representation of the first user preference profile to the shared ontology; generating a confidence indication for at least some of the first user preference data; and transmitting the first user preference data and the confidence indication to a second recommender of the plurality of recommenders.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a recommendation system in accordance with some embodiments of the invention;

FIG. 2 illustrates an example of a recommender in accordance with some embodiments of the invention;

FIG. 3 illustrates an example of an ontology mapping;

FIG. 4 illustrates an example of a recommendation server 109 in accordance with some embodiments of the invention; and

FIG. 5 illustrates an example of a method of operation for a recommendation system in accordance with some embodiments of the invention.

### DETAILED DESCRIPTION OF SOME EMBODIMENTS OF THE INVENTION

The following description focuses on embodiments of the invention applicable to a recommender for content items such as multimedia clips, radio programmes, text documents etc. However, it will be appreciated that the invention is not limited to this application but may be applied to many other user selection applications.

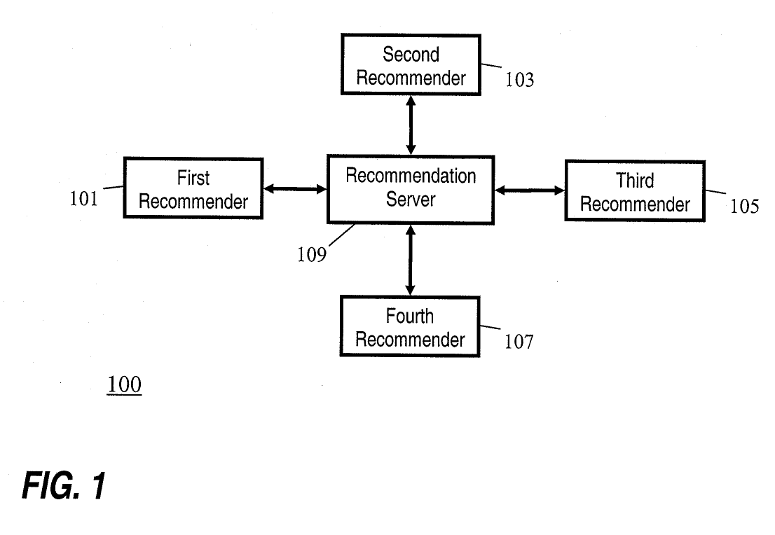

FIG. 1 illustrates an example of a recommendation system in accordance with some embodiments of the invention. The recommendation system comprises a plurality of recommenders 101-107 which in the example are content item recommenders for content items such as multimedia clips, online documents, radio programmes, podcasts, television programmes, websites etc. Furthermore, each of the recommenders 101-107 is an individually designed recommender which is directly targeted at a specific domain of recommendations. Thus, in the example, each of the recommenders 101-107 can provide recommendations within a specific domain independently of the other recommenders 101-107.

Furthermore, the individual recommenders 101-107 are based around individual recommendation algorithms that are specifically optimised for the individual recommendation domain. Each of the recommenders 101-107 is arranged to generate a user preference profile for a user of the recommender. The user preference profile may e.g. be based on monitoring user behaviour when consuming content items and/or may be based on explicit user inputs (e.g. preference descriptions or item ratings).

In the system, each of the recommenders 101-107 uses a different representation for the user preference profile. For example, some recommendation algorithms may be based on complex and possibly probabilistic user preference models whereas other algorithms may be based on simple taxonomy user preference profiles.

In particular, the different recommenders 101-107 not only model different dimensions of a user's preferences (e.g. films, TV shows or books) but also model the user preferences differently. Typically, the user preference profiles are targeted to the specific problem domain of the recommender 101-107 and depend on the recommendation algorithm.

As an example, each of the recommenders of FIG. 1 may correspond to a different content access device used by the same user. For example, one recommender may be comprised in a Personal Video Recorder (PVR) generating recommendations for television programmes, another may be comprised in a mobile phone generating recommendations for mobile television (DVB-H), another may be comprised in a laptop computer generating recommendations for web sites, another may comprised in a desktop computer generating recommendations for podcast downloads etc.

Typically each of the recommendation algorithms is designed independently of other recommendation algorithms and is directly targeted at the specific application. As such, both the recommendation algorithm and the user preference profile are designed for the specific domain and application scenario and accordingly they may vary widely between the individual recommenders 101-107.

However, although recommenders have typically been considered as independent, isolated and self contained entities, the system of FIG. 1 allows such diverse recommenders 101-107 to interwork and specifically to exchange and share user preference information. This sharing of user preference information may provide the individual recommender 101-107 with improved user preference data that may improve the generated recommendations. For example, more reliable user preference data may be obtained as it can be based on a larger sample of user behaviour. Alternatively or additionally more diverse user preference data may be obtained by the individual recommender 101-107 since data can be obtained that reflects the user's preferences for other applications and use scenarios.

In the example, the recommendation system uses a shared ontology to exchange user preference data between recommenders 101-107. Accordingly, each of the recommenders 101-107 comprises functionality for translating user preference data from the internally used representation to the shared ontology representation. This user preference data can then be communicated to other recommenders 101-107 which comprise functionality for translating the user preference data from the shared ontology representation to their internal representation. Furthermore, the exchanged user preference data is designed to include a confidence indication which is indicative of a degree of reliability or confidence of the exchanged data. Thus, a receiving recommender can process received user preference data depending on how reliable it is indicated to be thereby providing an improved weighting of the received user preference data when e.g. combining or merging it with the existing internal user preference profile.

In the example, all the recommenders 101-107 are coupled to a common recommendation server 109 which is operable to receive user preference data from any of the recommenders 101-107 and to forward it to any of the other recommenders 101-107. The recommendation server 109 may e.g. be implemented in a home computer of the user and the communications between the recommenders 101-107 and the recommendation server 109 may e.g. be via a wireless home network such as a Wireless Local Area Network (WLAN). As another example, the recommendation server 109 may be implemented in a remote server, such as a remote Web server.

The recommendation system thus provides for sharing of common user preference information between domain-specific recommenders based on a generic shared ontology. The domain-specific recommenders 101-107 can use their own individual internal representations (e.g. their own ontology/taxonomy representation or other more domain-specific representations, such as complex user preference models). The approach may for example be highly backwards compatible as it may allow user preference information sharing between recommenders without requiring any modification of the recommendation algorithm itself or of the data representation of the user preference profile. In other words, the functionality required for sharing or exchanging user preference data can simply be added to an existing system.

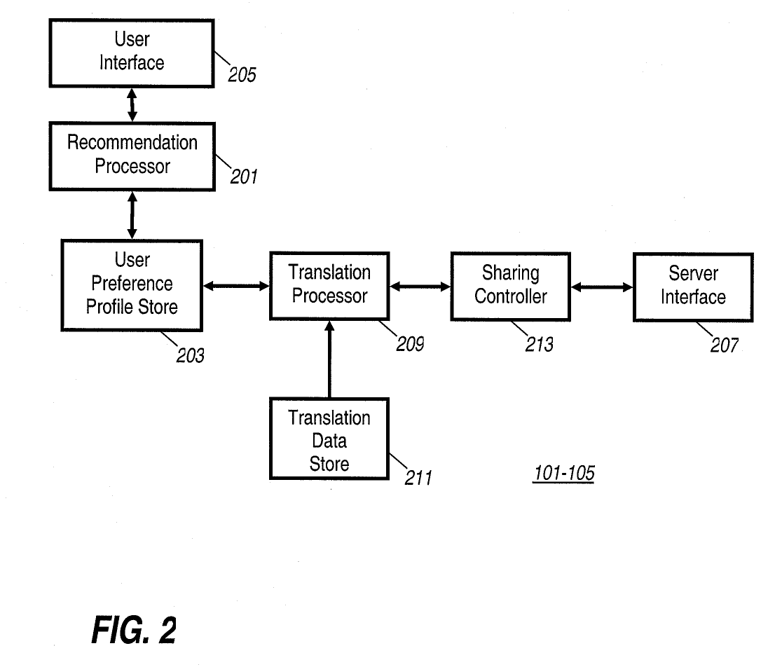

FIG. 2 illustrates an example of elements of a recommender in accordance with some embodiments of the invention. In the example, all the recommenders 101-107 comprise the functionality illustrated in FIG. 2 and accordingly FIG. 2 may be considered an illustration of any of the recommenders of FIG. 1.

In the following, an example of the operation of the recommendation system of FIG.1 will be described for a scenario wherein the first recommender 101 generates user preference data which is transmitted to the second recommender 103. The user preference data is generated by translating the data from the first recommender's 101 user preference profile into user preference data in accordance with the shared ontology representation. The second recommender 103 then translates the received user preference data from the shared ontology representation into the specific representation used by the second recommender 103 and combines the resulting data with the existing user preference profile used by the second recommender 103.

The transmitting operation of the first recommender will first be described with reference to FIG. 2.

The first recommender 101 comprises a recommendation processor 201 which is coupled to a user preference profile store 203 wherein a user preference profile is stored. The recommendation processor 201 can generate recommendations based on the user preference profile and the resulting recommendations can be presented to a user via a user interface 205 coupled to the recommendation processor 201.

The recommendation algorithm is an algorithm specifically designed for the specific recommendation application and the user preference profile is organised in accordance with a recommender specific representation which in the specific example is predefined. Specifically, the algorithm and user preference profile representation may be integrated such that the recommendation algorithm design inherently includes a definition of the structure, composition and organisation of the user preference data in the user preference profile.

Thus, whereas the specific user preference data generated and stored in the user preference profile is not known during the design phase, the representation of the user preference profile is predefined. Thus, although the specific content of the user preference profile cannot be known in advance, the representation of the user preference profile is independent of the specific user data and can accordingly be known independently of, and prior to the use of, the recommender.

In the specific example, the user preference profile is specifically a complex probabilistic user model which is based on monitoring the user's behaviour. The model is able to model user preferences for items that may be recommended. The probabilistic model may specifically generate a probability that a given user may like a specific item.

In the specific example, the first recommender 101 may be a personal computer allowing access to a shared repository of text documents. For example, the personal computer may access a centralised text document store over the Internet and the recommendation algorithm may be arranged to generate recommendations for specific text documents. Furthermore, the recommendation processor 201 may detect the user's selections and downloads of individual text documents and may use this information to adapt the probabilistic user model to the user's preferences.

The user preference profile store 203 is coupled to a translation processor 209 which is arranged to translate user data of the user preference profile into user data arranged in accordance with the shared ontology.

Since the user preference profile representation and the shared ontology can be predetermined and/or predefined, translation data representing how user data can be translated from the recommender specific representation to the shared ontology (or vice versa) can also be predetermined. In the specific example, translation data relating the recommender specific representation to the shared ontology is stored in a translation data store 211 coupled to the translation processor 209.

The first recommender 101 furthermore comprises a sharing controller 213 coupled to the translation processor 209. The sharing controller 213 is arranged to control the sharing of user preference data by the first recommender 101. The sharing controller 213 is furthermore coupled to a server interface 207 which is operable to communicate with the recommendation server 109. The server interface 207 may for example comprise WLAN communication functionality.

In the example, the first recommender 101 may generate user preference data and transmit this to other recommenders 103-107 via the recommendation server 109. For example, at regular intervals, the first recommender 101 may initiate a process which generates and transmits user preference data to the recommendation server 109.

When the first recommender 101 initiates a user preference data transmission process, the sharing controller 213 requests user preference data from the translation processor 209. In response, the translation processor 209 retrieves user preference data from the user preference profile store 203 and translation data from the translation data store 211. It then proceeds to generate user preference data in accordance with the shared ontology from the retrieved user preference data as controlled by the translation data.

It will be appreciated that the translation data reflects the individual characteristics of the internal representation and is accordingly different for different representations. Additionally, the translation algorithm may also be different in different recommenders and may specifically depend on the type of user preference profile used by the individual recommender. For example, for user preference profiles where the user preference data is simply organised in accordance with a taxonomy, a relatively simple translation algorithm may be based around simply linking specific categories of the internal taxonomy with specific categories of the shared ontology. The information of which specific categories are linked to each other is stored in the translation data.

In the system of FIG. 1, the translation processor 209 generates a confidence indication for at least part of the user preference data. Thus, in addition to the actual data describing the user's preferences, data is also provided which indicates how reliable the preference data is. For example, the confidence indication may comprise a confidence measure for individual categories of the shared ontology. E.g. for one or more categories for which the user preference data includes a user preference indication, a confidence measure is also included to reflect how accurate that user preference indication is considered to be by the recommender 101.

In some embodiments, the recommender 101 may use a user preference profile generation algorithm which automatically generates confidence measures for the generated data. For example, for a learning algorithm that generates user preference profile date in response to user selections of content items, the number of selections that have been detected and used to generate a specific user preference value may inherently be used to provide a confidence measure for that value.

Thus, the user preference profile may itself generate and store confidence levels for the stored data. Specifically, the user preference profile can comprise confidence measures for individual user preference data items and the translation unit can generate the confidence indication in response to the confidence measures. As a simple example, a confidence measure for a user preference item which is directly linked to specific category can be assigned as the confidence measure for that category.

However, the confidence indication does not necessarily have to be a value that the recommender already calculates as part of the user model. For example, the recommendation algorithm and/or the user preference profile generation algorithm may not consider confidence values at all but rather the confidence indication may be generated independently by the translation processor 209.

As a specific example, for one or more categories of the shared ontology, a confidence measure may be given as a normalised numeric value (e.g. between 0 and 1). The meaning of the confidence measures may be defined as part of the definition of the shared ontology (e.g. with a value of 1 indicating that the recommender is absolutely certain and a value of 0 indicating that the recommender has no information about user preferences regarding the specific category).

The confidence measures can e.g. be calculated based on different heuristics depending on the specific algorithm. For example, a larger confidence value may be attributed to explicit user ratings than to implicit user ratings; in case of implicit ratings, the number of examples (e.g., ranked items) used to reach the user preference value can be used as a measure of confidence etc.

In some embodiments, the confidence indication may additionally or alternatively reflect a confidence indication for the translation from the recommender specific representation to the shared ontology representation. Specifically, the translation processor 209 may generate the confidence indication in response to a correspondence between user preference data items of the first user preference profile and categories of the shared ontology.

For example, if an individual preference item of the user preference profile corresponds directly to a category of the shared ontology (e.g. both are defined as “Football”), a high confidence indication may be generated for the user preference data for this category. However, if the correspondence is lower reflecting that the preference item and the shared ontology category do not have exactly the same meaning or scope (e.g. a user preference item may be defined as relating to “Hobbies” whereas the shared ontology category is defined as “Free time activities”) the confidence measure is set lower to reflect that it is less likely that the generated user preference accurately reflects the users preference for the specific category.

It will be appreciated that any suitable function or algorithm defining a correspondence measure may be used. For example, the translation data may itself include a predefined translation confidence measure for each possible user preference item and shared ontology category pairing.

Thus, the generated user preference data not only comprises data reflecting the user's preferences as determined by the individual recommender but also includes confidence data that indicates the estimated likelihood of this data accurately predicting the user preferences. Furthermore, this confidence data may reflect the underlying confidence in the user preference profile of the recommender but may also (or alternatively) reflect the potential reliability loss incurred by the translation of the user preference profile data into data represented in accordance with the shared ontology.

When the translation processor 209 has generated user preference data structured in accordance with the shared ontology, this data is fed to the sharing controller 213 which proceeds to transmit it to the recommendation server 109 using the server interface 207.

The recommendation server 109 forwards the user preference data to the second recommender 103. Thus, in the example the user preference data is transmitted from the first recommender 101 to the second recommender 103 via the recommendation server 109. However, it will be appreciated that in other embodiments, the user preference data may be transmitted directly between the recommenders 101-107. For example, the recommendation system may use a peer-to-peer network structure rather than the centralised approach of FIG. 2.

The operation of the second recommender 103 will in the following be described with reference to FIG. 2. Thus, in the example, the functionality of the exemplary recommender of FIG. 2 is illustrated by the first recommender 101 for the user preference data generation and transmission phase and by the second recommender 103 for the user preference data receiving and recommendation phase.

Similarly to the first recommender 101, the second recommender comprises a recommendation processor 201 coupled to a user preference profile store 203 and a user interface 205.

The recommendation processor 201 generates recommendations for content items based on the user preference profile but uses a different representation and recommendation algorithm than the first recommender 101. Also, the recommendation domain of the second recommender 103 can be different than the first recommender 101.

In the specific example, the second recommender 103 is a PVR arranged to generate recommendations for television programmes. Accordingly, the recommendation algorithm and user preference profile are designed specifically for this purpose.

The second recommender 103 also comprises a server interface 207 which receives the user preference data from the recommendation server 109. The server interface 207 is coupled to a sharing controller 213 which controls the receiving process and which receives and forwards the user preference data to the translation processor 209. The translation processor 209 is coupled to a translation data store 211 and the user preference profile store 203 and is arranged to translate the received user preference data represented according to the shared ontology into user preference data represented in accordance with the recommender specific representation used by the user preference profile of the second recommender 103. Specifically, the translation processor 209 retrieves translation data which relates the shared ontology to the recommender specific representation of the second recommender 203 and uses this translation data to generate user preference data compatible with the user preference profile.

The translation data may for example relate different shared ontology categories to specific data items of the user preference profile (e.g. to specific categories of a taxonomy used by the user preference profile).

The translated user preference data may then be incorporated into the user preference profile of the second recommender 103. For example, the generated user preference data may be added to existing data and/or an averaging of the data may be performed. It will be appreciated that the specific combining of the translated user preference data and the existing user preference data of the user preference profile will depend on the specific characteristics and requirements of the individual embodiment.

Furthermore, the translation processor 209 is arranged to generate a confidence measure for the translated user preference data in response to the included confidence indication. For example, a weighting of the received translated user preference data relative to the already existing data may be dependent on the degree of confidence in the received data.

As a specific example where the internal representation of the second recommender 103 is a simple taxonomy, the translation data may directly relate categories of the shared ontology and categories of the taxonomy. The translated user preference data for a specific taxonomy category may accordingly be determined as the received user preference data value for the corresponding shared ontology category. Similarly, the confidence measure for the translated data for the specific taxonomy category may be determined as the received confidence measure for the corresponding shared ontology category. A new user preference value for the taxonomy category can then be determined by a weighted summation of the existing value and the new value wherein the weighting is determined by the confidence measure. E.g. for a very high confidence value, the preference value may be set almost exclusively to the received preference data value, and for a very low confidence value no change may be introduced to the existing data. If no previous data exists for a taxonomy category, the received translated value may simply be used.

The recommendation processor 201 may then proceed to generate recommendations based on the updated user preference profile. Thus, the generated recommendations will depend both on the actual preference data generated by the first recommender 101 and on the reliability of this data as indicated by the confidence indication. Specifically, the consideration of the reliability of the received data provides for a much more reliable combination of existing and received data thereby providing significantly more accurate recommendations.

Thus, the described system may enable or facilitate distribution and promulgation of personalisation data thereby e.g. allowing modelling of user preferences to expand across multiple devices and applications. The approach may for example allow a more diverse generation of recommendations. For example, in the specific case, the second recommender 103 can generate a recommendation for a television program relating to a specific author as a result of the user downloading a number of text documents by this author using the first recommender 101. As another example, a person selecting text documents such as news, articles etc about football can be recommended a football match being televised. Thus, although the user has expressed no previous interest in similar television programmes, the user behaviour in a different domain can be used to provide more diverse recommendations.

Furthermore, a significantly more accurate recommendation can be achieved by a given user preference profile being determined in response to more substantial user preference data. For example, for user preference profiles generated on the basis of user behaviour a larger sample of user actions can be considered thereby providing a higher accuracy. Furthermore, as confidence measures are considered, the combination or merging of such data can be achieved with a high degree of reliability.

An ontology may be considered a data model that represents a set of categories (concepts) within a domain and the relationships between those concepts. The shared ontology may specifically be a taxonomy and may specifically comprise a hierarchical arrangement of individual categories.

The shared ontology may thus specifically specify a plurality of interrelated categories with the specific user preference data providing individual user preference indications for at least some of the categories. The user preference indication for a category may for example be a user rating or may alternatively or additionally be a probability indication for the category. The probability indication may represent the estimated likelihood of the user having a preference for the content. The confidence indication for a category accordingly reflects how accurate or reliable the user preference value (e.g. the user rating or the probability indication) is considered to be.

More specifically, in the example, common content-related preference information is represented by a generic shared ontology defined for all recommenders independently of their internal user preference profile representations. The shared ontology may specifically be a public standardised ontology.

User preferences are communicated between different recommenders by associating preference values to the different categories of the ontology. In the specific example, each category is associated with the following information:
A probability value: a value specifying the probability of the user being interested in this category; and
A confidence value: the reliability of the preference information associated with this category.

In some embodiments, a category may furthermore comprise refinement data that represents a more detailed characterisation of the user preference than represented by the category itself Thus, the refinement data may further characterise the user preference e.g. in terms of a further characterisation of the type of content the user preference relates to. As a specific example, a category may relate to the concept of “Sport” and may comprise a probability indication that indicates a high likelihood of the user having a preference for the concept. Furthermore, the confidence indication may indicate that the probability indication is considered highly reliable. In addition, refinement data may furthermore characterise the user preference as specifically relating to a specific football team, a specific tournament etc.

Thus, when translating data from the internal representation to the shared ontology, the translation processor 209 may also generate refinement data for one or more categories. Specifically, refinement data may be added to categories which are broader than the specific concept the internal user preference relates to. For example, the internal representation may comprise the concept “Football Team” whereas the shared ontology may only include the category “Football”. The translation processor 209 can accordingly set the user preference for the category “Football” in response to the user preference for the concept “Football Team”. However, as the internal concept does not directly correspond to the shared ontology category the confidence measure is reduced. Furthermore, refinement data which specifies the specific football team of interest to the user is included.

Accordingly, a recommender receiving the generated user preference data may use the refinement data to provide more accurate translated data. For example, if the second recommender 103 has an internal user preference profile representation that includes the concept “Football Team”, the translation data may specify that for the shared ontology category “Football” any refinement data should be checked to see if a specific football team is defined. If so the translated user preference data is modified to reflect this.

The added refinement data may specifically be specified as optional and may accordingly be used by some recommenders whereas it is simply ignored by other recommenders.

The refinement data may specifically be defined by an optional set of keywords. Each keyword can be associated with a value that reflects the user interest in content containing that keyword (in case of video content or other non-text content, the keywords could be determined from associated metadata).

It will be appreciated that the translation between the internal recommender specific representation and the shared ontology representation (or vice versa) will depend on the specific characteristics of the representations.

In some embodiments, the internal recommender specific representation may for example be a recommender specific ontology or taxonomy representation. For such recommenders, a relatively low complexity translation may be feasible and can basically consist in the translation data defining an ontology mapping between the internal and the shared ontologies.

The shared ontology may e.g. be constructed such that it completely encompasses the internal ontologies thereby providing a direct mapping between equivalent categories and allowing a straightforward translation. However, in other embodiments some or all of the categories may not be identical and the translation data can specify associations between non-identical categories, possibly with an associated data processing, such as e.g. a determination of a confidence measure that reflects the correspondence between the linked categories.

The translation data may thus directly link the categories of the internal ontology and the categories of the shared ontology. The category linking may for example specify that no corresponding category exists for a specific category and that accordingly the associated user preference data should be ignored. For example, if the internal ontology does not contain any categories related to “Football Teams” (e.g. because the recommender is addressed to the domain of recommending music), the data of the category “Football Teams” of the shared ontology is simply ignored. As another example, the translation data may link a more detailed category to a more general (broader) category. For example, if the internal ontology comprises a category for “Football” the translation data may specify that the user preference data from the shared ontology category of “Football Team” should be included therein (possibly after some processing or combination with other user preference data).

Although precise and highly accurate ontology mapping may be difficult to achieve for many complex ontologies due to different levels of abstractions, different meanings of different categories etc, the current approach is highly amenable to translation based on such mapping. For example, the approach does not require a one-to-one category mapping as the translation data may specify how non-matching categories can be handled. Also, the more generic categories are likely to be more important in reflecting user preferences and these are more likely to be translatable between different ontologies. Furthermore, the translation data allows a manual translation to be defined which can reflect the desired characteristics.

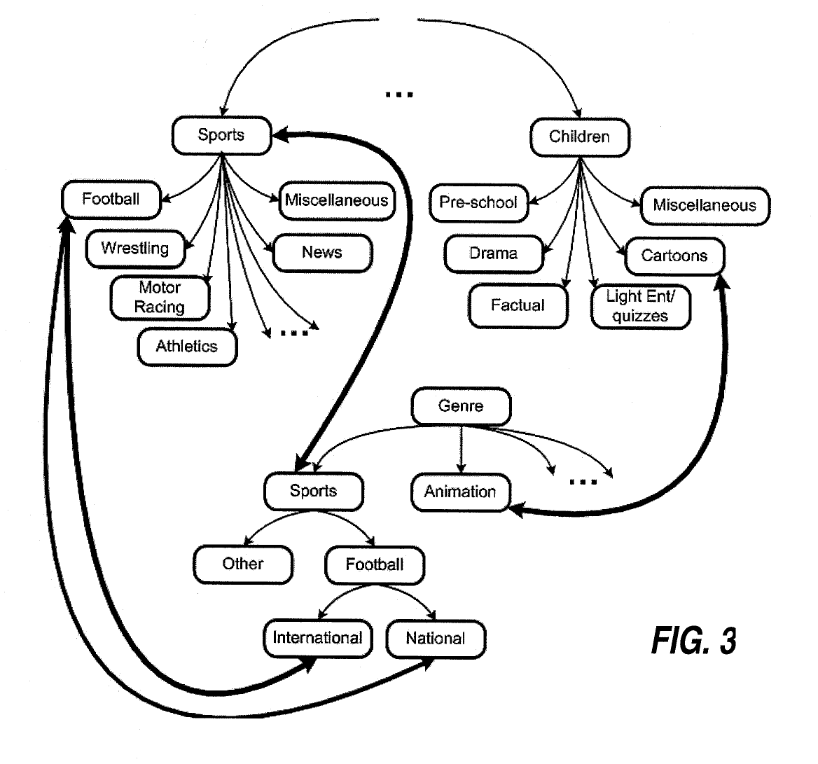

An example of an ontology mapping is illustrated in FIG. 3.

For some recommenders, the recommender specific representation may not be an ontology representation.

For example, the user preference profile can comprise a learning user preference model wherein the user's preferences are learned over time in response to the user's behaviour or user's ratings of particular items. For example, when a user selects a specific content item, the model is amended to reflect an increasing preference for content items having characteristics similar to the characteristics of the selected or positively rated content item.

It will be appreciated that the skilled person will be aware of many different approaches and algorithms for generating a user preference model in response to a monitoring of user behaviour. It will also be appreciated that although the user preference profile generated by a learning process may be represented by an ontology, it will in many embodiments by represented by a complex user preference model that allows a user preference value to be calculated by evaluating the model for a specific set of content item characteristics.

In some embodiments, the confidence indication can be determined in response to the user behaviour. For example, the confidence measure for user preference data of a given shared ontology category may be set in response to a number of user behaviour actions that have contributed to determining the preference data. Thus, the recommender can determine the confidence measure for a specific user preference data item in response to the number of user actions that are associated with the user preference data item. Thus, if content items relating to a specific category have been selected many times by a user, this may not only be considered to be likely to indicate a high preference for the category but also a high confidence in this preference. However, if only one content item of a specific category has been available to the user, the selection thereof may be considered to reflect a preference value for the category. However, as the assumption is based on only one user action, the confidence of the preference is considered relatively low.

In some embodiments the confidence measure for a user preference data item can be determined in response to the degree that the user preference data item is determined from a user input. For example, if the user preference data is obtained by a user explicitly stating a preference for the associated category, the confidence measure may be set relatively high. However, if the user preference data is implicitly determined based on the user behaviour, the confidence measure may be set depending on the amount of user actions that have been evaluated to determine the preference data. For intermediate scenarios, e.g. where a user preference data for a specific user preference data item of the user preference model/user preference profile is determined based on user selections combined with user ratings of some of the selected items (rather than the category itself), the confidence measure may be set in between these values.

In some recommenders, the user preference profile may comprise a probabilistic user preference model. In such a probabilistic user preference model the generated user preference model may be used to indicate a perceived probability that the user has a preference for a given item with certain characteristics.

Specifically, the probabilistic user preference model can comprise a Bayesian network. A Bayesian network (or a belief network) is a probabilistic graphical model that represents a set of variables and their probabilistic dependencies. Such a network may represent different categories and their probabilistic interrelations and are suitable for generating user preference predictions.

For example, a recommender using a Bayesian network for generating recommendations in the domain of mobile television (DVB-H) may have an associated probability for each DVB-H genre. These genres can be translated into the shared ontology categories and the probability values associated with the different genres can be used as the preference values for the individual shared ontology categories. E.g. for each different genre i, the probability of the user liking this genre, Pr(P_{Liking}|Gᵢ), can be calculated as:

$$Pr ( {P}_{Likiing} \vert {G}_{i} ) = \frac{Pr ( {P}_{liking} ) Pr ( {G}_{i} \vert {P}_{liking} )}{{\sum }_{j ∈ \{ liking , not liking \}} Pr ( {P}_{j} ) Pr ( {G}_{i} \vert {P}_{j} )}$$

This value may accordingly be used as the user preference value for the category corresponding to the genre i. The translation data may accordingly specify both the equation and the linking between the genre i and the corresponding shared ontology category.

Although the Bayesian network may not directly determine a confidence measure for the generated user preference data, this can be determined independently by the translation processor 209. For example, the number of examples used to calculate the probabilities can be used for this purpose. For example, it may be decided that a 100% confidence is achieved when the system has seen one hundred (or more) examples for the particular category in question, and that confidence values are decreased for fewer examples.

The translation from the shared ontology to genre categories can be used to update the user preference model of a Bayesian recommender. E.g. after the appropriate genre has been identified (by use of the translation data), the Bayesian recommender can be provided with a number of examples for the specific genre value and an indication of a liking or non-liking attribute (all other example attribute values can be omitted). The number of examples shown can be proportional to the confidence of the shared information (e.g. 100 examples are provided for a 100% confidence and a decreasing number of examples for lower confidence values) e.g. weighted by a fractional constant (reflecting that external information should be assigned less value). The proportion of liking and non-liking examples should be in agreement with the shared probability. Thus, in this case the received user preference data is not directly merged with existing data but is rather used to generate training data for the model where the training data has characteristics reflecting the received translated user preference data.

In the example, the communication between recommenders is via a centralised recommendation server 109 to which the recommenders 101-107 are coupled. In the specific centralized approach, all the domain-specific recommenders 101-107 communicate with the central recommendation server 109. In the example, a registering mechanism is used to register the user uniquely within the recommendation server 109. This can e.g. consist of a login username and password mechanism.

In the example, the recommenders 101-107 send their user preference data to the recommendation server 109 in the format defined by the shared ontology (e.g. after encryption or any other necessary transformation for network transmission). This may e.g. be done regularly or as soon as the recommender 101-107 has enough new information to transmit.

The recommendation server 109 can in some embodiments process the information received further. For example, it can calculate measures of similarity of the user preferences provided by any two domain-specific recommenders 101-107. This information can be used as a measure of trust when individual recommenders 101-107 use each others information. Thus, in some embodiments, the recommendation server 109 can modify the confidence indication in response to a comparison of user preference data for the recommenders sharing data. For example, it may include an additional confidence measure in the confidence indication reflecting the similarity between the recommenders. For example, if preferences for all users which are common to two individual domain-specific recommenders 101-107 are very similar then the domains can be considered to be closely related and a high confidence measure may be included. The usage of shared data by a recommender 101 may accordingly be dependent on this confidence measure. For example, the shared data may be ignored if the confidence measure is below a given level.

The shared ontology may be determined such that it is likely to include a wide variety of domains and thus such that it will be suitable for any of the domains of the different recommenders being considered. The shared ontology can be as broad and as detailed as needed. However, although the potential taxonomy can be complex, the actual user preference data transmitted can in many embodiments be limited to the appropriate information and in particular to the data which is modelled by the recommender sending the information.

Furthermore, the communicated data may be limited to that which is appropriate for the receiving recommender. E.g. in a server-based approach, the server 109 can filter the user preference data transmitted to the individual recommenders depending on their modelling needs. In a peer-to-peer approach, recommenders can learn about other recommenders (e.g., from the user preference data being received from the other recommenders) and can select the user preference data to transmit accordingly.

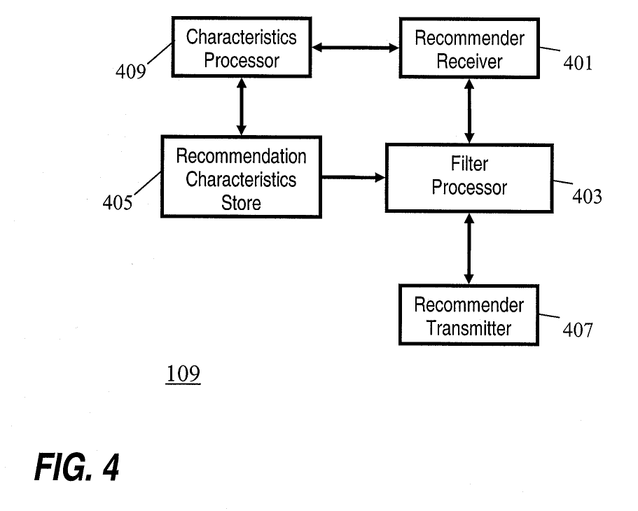

FIG. 4 illustrates an example of some elements of the recommendation server 109 in accordance with such a centralised embodiment.

The recommendation server 109 comprises a recommender receiver 401 which receives the user preference data from the first recommender 101.

The recommender receiver 401 is coupled to a filter processor 403 which is further coupled to a recommendation characteristics store 405 which stores recommendation characteristics for the individual recommenders 101-107. The recommendation characteristics store 405 can specifically store information of which categories of the shared ontology are likely to be relevant for the individual recommenders 101-107.

The filter processor 403 may then proceed to filter the received user preference data in response to a recommendation characteristic for the second recommender 103. Specifically, the filter processor 403 can extract the information of which categories are likely to be of interest to the second recommender 103 and can discard all user preference data not belonging to these categories. The resulting reduced user preference data is then fed to a recommender transmitter 407 coupled to the filter processor 403. The recommender transmitter 407 then transmits the reduced user preference data to the second recommender 103.

In the example, the recommendation server 109 furthermore comprises a characteristics processor 409 coupled to the recommender receiver 401 and the recommendation characteristics store 405. The characteristics processor 409 is arranged to determine the recommendation characteristic for the second recommender 103 in response to user preference data received from the second recommender 103.

For example, the characteristics processor 409 can detect which categories of the shared ontology are represented in user preference data received from the second recommender 103 and may set the recommendation characteristics to reflect that user preference data transmitted to the second recommender 103 should include these categories.

In embodiments wherein the recommenders communicate directly without a central server, the individual recommender may be arranged to select user preference data that is transmitted to another recommender in response to a recommendation characteristic for the other recommender. For example, the functionality described for the recommendation server 109 of FIG. 4 may be implemented in each of the recommenders.

In the described embodiments, the shared ontology user preference data is by the individual recommender 101-107 translated into the internal representation used by that recommender and merged with an existing user preference profile. However, it will be appreciated that in some embodiments, the shared ontology user preference data may be used directly without any further translations. For example, a common user preference profile may be generated by combining user preference data received from a plurality of individual recommenders where the user preference data is represented in accordance with the shared ontology. The common user preference profile may itself be represented in accordance with the shared ontology.

This may e.g. allow a larger user preference profile to be generated which includes user preference data relating to all the domains considered by the plurality of recommenders 101-107.

The combination of the individual user preference data is furthermore in response to the confidence indications for the user preference data. Thus, user preference data which has a high associated confidence measure is weighted higher than user preference data which has a low associated confidence measure. As a specific example, the user preference data value for a given shared ontology category can be determined as a weighted summation of the user preference data values received for that category with the weights being given by the confidence value of each individual user preference data value.

Thus, alternatively or in addition to having the shared information incorporated back into individual domain-specific recommenders, a single unified user profile can be created which simply averages the user preference data from different recommenders. The unified user profiles can be used to directly create recommendations (of items classified within the generic category) e.g. when the domain-specific recommenders do not have enough information.

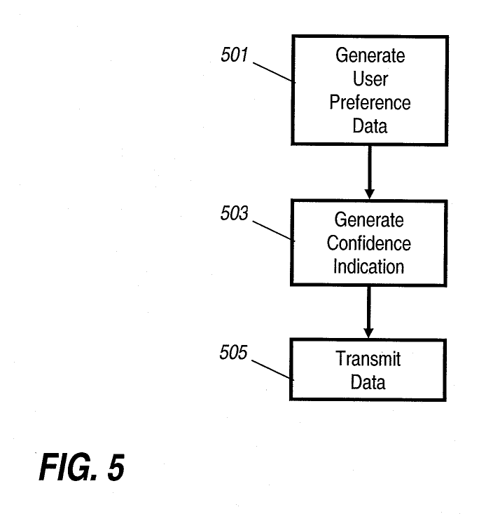

FIG. 5 illustrates an example of a method of operation for a recommendation system in accordance with some embodiments of the invention. The recommendation system comprises a plurality of recommenders for generating recommendations in accordance with a user preference profile having a recommender specific representation. The recommender specific representation is different for different recommenders of the plurality of recommenders and each recommender of the plurality of recommenders further comprise translation data relating the recommender specific representation to a shared ontology.

The method initiates in step 501 wherein a first recommender generates first user preference data represented in accordance with the shared ontology in response to a first user preference profile of the first recommender and first translation data relating a first recommender specific representation of the first user preference profile to the shared ontology.

Step 501 is followed by step 503 wherein a confidence indication for at least part of the first user preference data is generated.

Step 503 is followed by step 505 wherein the first recommender transmits the first user preference data and the confidence indication to a second recommender of the plurality of recommenders.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A recommendation system comprising:
a plurality of recommenders for generating recommendations in accordance with a user preference profile having a recommender specific representation, the recommender specific representation being different for different recommenders of the plurality of recommenders and each recommender of the plurality of recommenders further comprising translation data relating the recommender specific representation to a shared ontology,
wherein at least a first recommender of the plurality of recommenders comprises:
a translation unit for generating first user preference data represented in accordance with the shared ontology in response to a first user preference profile of the first recommender and first translation data relating a first recommender specific representation of the first user preference profile to the shared ontology; and
a transmitter for transmitting the first user preference data to a second recommender of the plurality of recommenders,
wherein the translation unit is further arranged to generate a confidence indication for at least some of the first user preference data and the transmitter is arranged to transmit the confidence indication to the second recommender.

2. The recommendation system of claim 1 wherein the first user preference profile comprises confidence measures for individual user preference data items of the user preference profile, and the translation unit is arranged to generate the confidence indication in response to the confidence measures.

3. The recommendation system of claim 1 wherein the translation unit is arranged to generate the confidence indication in response to a correspondence between user preference data items of the first user preference profile and categories of the shared ontology.

4. The recommendation system of claim 1 wherein the second recommender comprises:
a receiver for receiving the first user preference data;
a translation unit for generating second user preference data represented in accordance with a recommender specific representation of the second recommender in response to the first user preference data and translation data relating the shared ontology to the recommender specific representation of the second user preference; and
a recommendation unit for generating at least one recommendation in response to the second user preference data.

5. The recommendation system of claim 4 wherein the second recommender is arranged to generate a confidence measure for at least some of the second user preference data in response to the confidence indication, and the recommendation unit is arranged to generate the at least one recommendation in response to the confidence measure.

6. The recommendation system of claim 1 wherein the first user preference data comprises a probability indication for at least one category of the shared ontology; and the confidence indication comprises an indication of a confidence measure for the probability indication.

7. The recommendation system of claim 1 wherein the user preference profile comprises a probabilistic user preference model.

8. The recommendation system of claim 7 wherein the probabilistic user preference profile comprises a Bayesian network.

9. The recommendation system of claim 1 wherein the first recommender is arranged to adapt a learning user preference model of the user preference profile in response to a user behaviour, and to generate the confidence indication in response to the user behaviour.

10. The recommendation system of claim 9 wherein the first recommender is arranged to determine a confidence measure for at least some user preference data in response to an amount of user behaviour data associated with the at least some user preference data.

11. The recommendation system of claim 1 wherein the first recommender specific representation is not an ontology representation.

12. The recommendation system of claim 1 wherein the shared ontology comprises a plurality of interrelated categories, the first user preference data comprises a user preference value for at least a first category of the plurality of interrelated categories and the confidence indication comprises a confidence measure for the first category.

13. The recommendation system of claim 12 wherein the translation unit is arranged to generate refinement data for the first category in response to the user preference profile and to include the refinement data in the first user preference data for the first category, the refinement data representing a more detailed characterisation of a user preference than represented by the first category.

14. The recommendation system of claim 1 wherein the first recommender is arranged to determine a confidence measure for a user preference data item in response to a degree that the user preference data item is determined from a user input, and the translation unit is arranged to determine the confidence indication in response to the confidence measure.

15. The recommendation system of claim 1 wherein the first recommender is arranged to select at least some of the first user preference data in response to a recommendation characteristic of the second recommender.

16. The recommendation system of claim 1 comprising a server coupled to the plurality of recommenders, the server comprising:
a data store for storing recommendation characteristics for at least the second recommender;
a receiver for receiving the first user preference data from the first recommender;
a filter unit for filtering the first user preference data in response to the recommendation characteristic for the second recommender to generate reduced user preference data; and
a transmitter for transmitting the reduced user preference data to the second recommender.

17. The recommendation system of claim 16 wherein the server is arranged to determine the recommendation characteristic for the second recommender in response to user preference data received from the second recommender.

18. The recommendation system of claim 16 wherein the server is arranged to modify the confidence indication in response to a comparison of user preference data received from the first recommender and user preference data received from the second recommender.

19. The recommendation system of claim 1 further comprising a server for generating a common user preference profile by combining user preference data received from the plurality of recommenders, the user preference data being represented in accordance with the shared ontology and the server being arranged to weight the user preference data in response to the confidence indications.

20. A method of operation for a recommendation system comprising a plurality of recommenders for generating recommendations in accordance with a user preference profile having a recommender specific representation, the recommender specific representation being different for different recommenders of the plurality of recommenders and each recommender of the plurality of recommenders further comprising translation data relating the recommender specific representation to a shared ontology; the method comprising a first recommender of the plurality of recommenders performing the steps of:
generating first user preference data represented in accordance with the shared ontology in response to a first user preference profile of the first recommender and first translation data relating a first recommender specific representation of the first user preference profile to the shared ontology;
generating a confidence indication for at least some of the first user preference data; and
transmitting the first user preference data and the confidence indication to a second recommender of the plurality of recommenders.
